(19) United States
(12) Patent Application Publication
(10) Pub. No.: US 2026/0152836 A1
(43) Pub. Date: Jun. 4, 2026

(54) STRUCTURAL COMPOSITE WITH A POLYMERIC SURFACE FORMING METHOD

(71) Applicant: Nikolay Yurievich OVCHARENKO, Berlin (DE)

(72) Inventor: Nikolay Yurievich OVCHARENKO, Berlin (DE)

(21) Appl. No.: 18/840,115

(22) PCT Filed: Dec. 15, 2022
(86) PCT No.: PCT/RU2022/000373

§ 371 Date: Aug. 21, 2024

(30) Foreign Application Priority Data
Oct. 19, 2022 (RU) 2022127110

(51) Int. Cl. C23C 4/04; C23C 4/02

(52) U.S. Cl. CPC C23C 4/04; C23C 4/02

(57) ABSTRACT

A polymer-metal composite includes localized pre-preparation of a metal-containing substrate that includes forming, on the contact surface thereof, a set of salient asperities that are distributed chaotically or regularly with an area density of from 50 to 1000 asperities/mm2. In profile, asperities are in the form of protuberances and recesses with shaped contours and a maximum cross-sectional dimension of from 20 to 100 microns, the walls of the majority of protuberances and recesses being oriented at an angle of 45-90° to the contact surface. A polymeric mass is applied in a partially melted state and with a thickness of not less than 10 microns to the salient asperities with a bonding portion of said polymeric mass penetrates between the salient asperities, covering the exterior thereof and, by virtue of fluidity, occupying the vacant spaces of the pre-prepared protuberances and recesses.

The present invention relates to a technology for the production of machine components using polymer composite materials as a lining for the rubbing surfaces of machine parts, particular in plain bearings.

Currently, the main element of such machine parts as plain bearings are structural parts with an antifriction coating, including liners made of antifriction material, located between the shaft and the bearing housing itself.

Modern materials used for sliding surfaces in friction units of machine parts must provide a low friction, conformability, thermal conductivity, compatibility, high compressive strength, fatigue strength, wear rate, corrosion resistance. The currently widely used specialized antifriction composite materials based on high-molecular polymer matrixes have high parameters, but their widespread use is hampered by low thermal conductivity, which affects the heat removal from the friction zone of the bearing, thermal expansion, which affects the dimensions of products during the changing of thermal conditions, strength of joined elements and ease of technological application.

At the current time, there are no universal antifriction materials that would objectively have high parameters of all the above properties. In this regard, the most promising direction for the development of technologies for the production of friction units of mechanisms is the use of composite antifriction materials and the improvement of produced units made from dissimilar materials that combine complex properties of the materials used.

As a known published technical solution, it is advisable to note the fusion bonding of polymer and metal surfaces to produce a combined structural material (see DAKZ 11 2021 006 205.0, class B29C 63/22 (2006.01), published 21/12/2021 [1]).

The known technical solution [1] relates to the field of manufacturing combined structural materials consisting of metals and polymers.

The technical solution [1] consists in a method for producing a combined metal-polymer structural material.

The essence of the technology [1] is the formation of an integrated combined layer on the surface of the substrate. The component located on the surface of the substrate is selected based on its ability to absorb heating. The surfaces of the component and the substrate are mechanically joined, creating an area of mutual penetration of materials at the boundary of the joined surfaces.

The technological aspect of the solution [1] is the use of a polymer component, the placement of a metal element in it at a given depth for creation of a heating under electromagnetic field, the adhesion of the surfaces of the polymer component and the metal substrate by pressing and placing them in an electromagnetic field, creation of a heating zone at the boundary of the joined surfaces to a temperature sufficient to melt the polymer component of the combined layer and its adhesion to the surface of the metal substrate.

The solution [1] makes it possible to combine polymer and metal substrate into a combined product, which eliminates thermal deformations and stresses, and also preserves the geometric stability of the resulting product. The solution [1] is the basis for creating combined structural materials with wide potential for industrial use and high technical performance and operational indicators.

Combined units obtained according to [1] are successful for industrial use, since their innovative production provides conditions for reducing operating costs and, at the same time, increasing the level of manufacturability and competitiveness of the resulting products. However, these units are subject to constant growing consumer expectations and will require periodic modernization via the reconfiguring of equipment and making significant adjustments to the technology.

It should also be taken into account that the technological improvement of the physical and mechanical parameters of the bearing antifriction layers, due to the specificity and narrow focus of the technical field, will require the involvement of significant amounts of material and intellectual resources, which will likely be perceived as a significant limiting factor in improving the known technology [1] of fusion bonding of polymer and metal surfaces.

A method for producing a multifunctional composite coating (see RU2759274, class C23C10/36, pub. Nov. 11, 2021 [2]) should be considered as the closest technically to the claimed invention

The known method for producing a coating [2] relates to the field of mechanical engineering, and more precisely, to the field of producing antifriction layers used in plain bearings, bushings and other metal products and interfaces to reduce friction and wear of the work surfaces of machine components.

In accordance with the known solution [2], the method for producing a protective composite coating is characterized by the fact that the surface of a metal substrate is preliminary prepared by mechanical processing, a thermal diffusion layer with open porosity is formed, and an outer layer of an antifriction non-metallic composite is applied.

It is important that, according to the solution [2], mechanical processing involves the use of a cutting tool and the formation of a regular wavy relief and roughness within tolerance, the porosity of the thermal diffusion zinc layer is selected to 10%, and the antifriction non-metallic composite is obtained by mixing a binder based on a polymer dispersion, thinner and fine particles of polytetrafluoroethylene up to 5 μm in size.

As a result of the known solution [2], the strength of the coating layers increases, the service life increases, and the service cost of friction units decreases, which solves the problem of creating a method for producing durable composite coatings based on metal and polymer materials with high technical and operational parameters.

Based on the features of the known solution [2], the metal substrate used undergo a preliminary preparation procedure, which consists in the formation of a wavy relief of a certain shape and the necessary parameters, which is ensured by turning or milling with a mechanical cutting tool with adjusted settings to obtain the expected result.

At the same time, the described preparation procedure for accuracy of implementation must be carried out “manually”, i.e., under the direct control of a specialist or technologist who processes each substrate individually and subsequently sends it to the next technological stages.

However, it is important to note that the “manual” high quality of preparation of the surface relief allows producing only small amounts of products, with the practical impossibility of organizing a large-scale competitive serial production meeting the needs of large industrial enterprises.

Also, as a significant systemic disadvantage of the technology known [2] should be noted the need to recruit significant labor and energy costs for production, the use of many technological cycles, including “manual” ones, which together are not able to cover the costs of manufacturing individual units of products. It is not economically effective and can be justified and work only in cases of local or one-time use for production necessity.

The limitations of the technology [2] are also associated with the impossibility of its use for other polymer composites, for which it is impossible to mix a binder based on a polymer dispersion, a diluent and fine particles of polytetrafluoroethylene due to high processing and operating temperatures.

The technical problem of the proposed invention is the creation of a simple technology for combining polymer and metal-containing materials with a wide structural field of application and high technical and operational parameters.

The technical result of the proposed invention is the implementation of a non-standard and at the same time technological method of joining dissimilar materials, which is characterized by a simplified production cycle, implying a single stage of adhesion of dissimilar layers. The method provides an increase in the accuracy and strength of the bonding, as well as resistance to mechanical, chemical and temperature influence. As a result, a combined and destruction-resistant unit is formed, where one of the surfaces consists of a polymer (in particular antifriction) composite material.

The specified technical result is achieved and the designated technical problem is solved as a result of the fact that the method of bonding a polymer material and a metal-containing substrate to obtain a combined unit is characterized (a) by preliminary local preparation of the metal-containing substrate, which consists in the formation on the contact surface of a set of relief asperities chaotically or orderly distributed with a surface density from 50 to 1000 pcs/mm² and having shaped contours of protuberances and recesses with a cross-sectional size from 20 to 100 μm and with the orientation of the walls of most of the mentioned protuberances and recesses at an angle of 45-90° to the specified contact surface, (b) followed by control and diagnostic measurements of the geometric parameters of the specified set of relief asperities, (c) onto which a polymer material is applied in a partially molten state with a thickness of at least 10 μm, the joined area of which penetrates inside the relief asperities, externally covering them and, due to fluidity, occupies and envelops the free volumes of prepared protuberances and recesses, (d) which ensures heat dissipation from the joint and reduces the amount of thermal expansion of the produced unit, and, in the case of external mechanical force, ensures the emergence of counterforces preventing the separation or displacement of the bonded parts.

It is the best embodiment of the invention if the preparation of the metal-containing substrate is carried out mechanically, namely, it may include drilling or cutting (milling) or electrochemical or electrical discharge machining or electric arc or plasma or electron beam welding und etc.

According to a preferred embodiment of the invention, the protuberances and recesses are made in the form of chaotically located craters with their edges rising above the contact surface and with passages made deep into their central parts.

It is rational when implementing the invention if the recesses are made in the form of pores and/or holes, at the edges of which the protuberances are formed by the cooled material.

As a rule, when implementing the invention, the existing protuberances and/or recesses of a set of relief asperities are formed on the contact surface in an orderly manner in the form of successive rows, the distance between which exceeds the cross-sectional size of the largest protuberance and recess of the metal-containing substrate by no more than 1.5 times.

According to one of the possible embodiments of the invention, prepregs or inert fillers are applied to the recesses of the relief asperities of the substrate before bonding with the polymer material to minimize the volume of air cavities.

In accordance with the proposed inventive concept, a new technological method of combining a polymer material and a metal-containing substrate is proposed for patenting to obtain a combined component of mechanisms, in particular, as parts of plain bearings, resulting in a combined metal-polymer joint that has high thermal conductivity, tensile/compressive/shear strength, low thermal expansion.

The main feature of the proposed technical solution is the technological simplicity, which involves a single operation of bonding dissimilar layers to each other. This joint occurs without the use of complex operations to ensure adhesion, for example, the often-used intermediate layers and additional processing with multiple cyclic repetition.

The proposed solution provides a significant simplification of the technological process and leads to a reduction in production time, since there is no need to use specialized equipment and personnel, prepare technological requirements and train personnel. In addition, the absence of an intermediate layer at the adhesion area eliminates the long cycle of surface preparation and allows the use of the resulting combined units in chemically active environments without the risk of destruction of the material and reducing the strength of the joint as such.

The presented technological feature uses a single operation and provides the joining a polymer material and a prepared metal-containing substrate, which undergoes preliminary preparation by mechanical means without applying intermediate layers. The preparation is characterized by the formation on the surface of the future contact of a set of relief asperities in the form of chaotically or orderly distributed protuberances and recesses with a surface density of 50 to 1000 pcs/mm², with a cross-sectional size of 20 to 100 μm, with the orientation of their walls at an angle of 45-90° to the contact surface. This allows applying a polymer material that penetrates into the relief asperities, covering them and, due to the molten state, occupies and envelops the free volumes of protuberances and recesses. As a result, the emergence of counteraction forces prevents the separation or displacement of the bonded parts in the case of an external force or mechanical impact.

In accordance with the author's concept, the applied polymer material should cover in height the entire volume of relief asperities of the metal-containing pre-treated substrate and have a thickness of at least 10 μm.

The intensive heat dissipation from the joint area of dissimilar materials is achieved, which ensures a low temperature gradient up to several degrees Celsius between the polymer surface and the metal-containing substrate, if there are a total thickness of the polymer material of 10-500 μm and ordinary thermal operating conditions of the assembled unit, for example, as a structural element of a plain bearing.

It should also be noted that, when using a total polymer layer thickness of 10-500 μm under ordinary thermal operating conditions of mechanisms from −50° C. to +150° C., thermal expansion of the entire combined unit is less than 10 μm, which, in particular, provides thermal expansion less than the tolerance for the plain bearing most sizes.

The proposed bonding of dissimilar materials in accordance with the invention ensures high strength of the bonding and creates a combined unit with a high level of strength in the normal and tangential direction in relation to the joint area, which has stable physical and chemical properties when exposed to temperature and/or chemically active environments. The strength of the combined unit is directly affected only by the specific strength of the material used and not by the conditions for adhesion of materials themselves.

The use of technologically simple methods of mechanical preparation of the substrate surface and thermal methods of joining materials with different melting temperatures leads to a significant reduction in the cost of manufacturing of finished products due to a reduction or elimination of the use of consumables, as well as due to a reduction in the number of production cycles. This, in turn, significantly increases the industrial potential of the presented technology and creates preferable economic conditions for full-scale serial production of the product.

It should be additionally noted that the use of a total polymer layer thickness in the range of 10-500 μm is capable to compensate the lower thermal conductivity and higher coefficient of thermal expansion of the polymers and ensure sufficient heat dissipation from the joint area and minimize the thermal expansion of the entire combined unit when used as parts of plain bearings.

The surface of the metal-containing substrate prepared in this way does not require additional treatment to increase adhesion by other methods, such as chemical or application of intermediate layers.

Thus, the proposed process for obtaining combined components of mechanisms with a polymer (in particular, antifriction) surface forms a set of necessary features sufficient to achieve a non-standard and technological method of joining dissimilar materials, which is characterized by a simplified production cycle, implying a single stage of adhesion of dissimilar layers, during which an increase in the accuracy and strength of the joint is observed, as well as its resistance to mechanical, chemical and temperature influence. As a result, a combined and destruction-resistant unit with a polymer (in particular, antifriction) surface is formed. The new non-standard technology for joining a polymer and a metal is created, which solves the existing technical problem and has a wide area of application and high production and technical and economic potential.

FIG. 1a, 1b, 1c show the prepared contact surface of the metal-containing substrate;

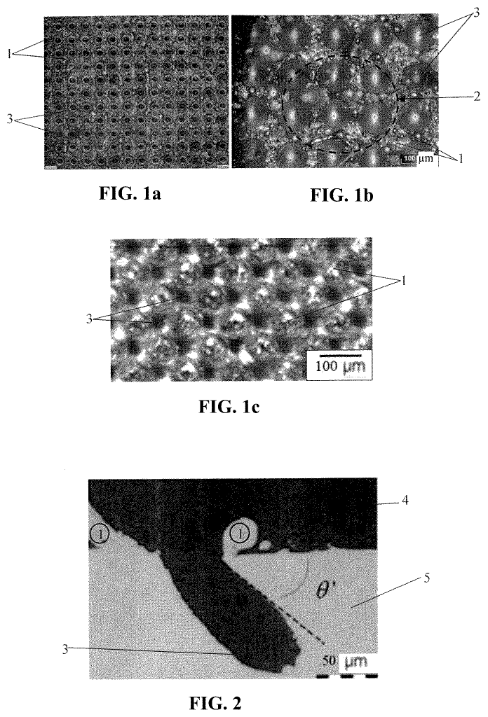

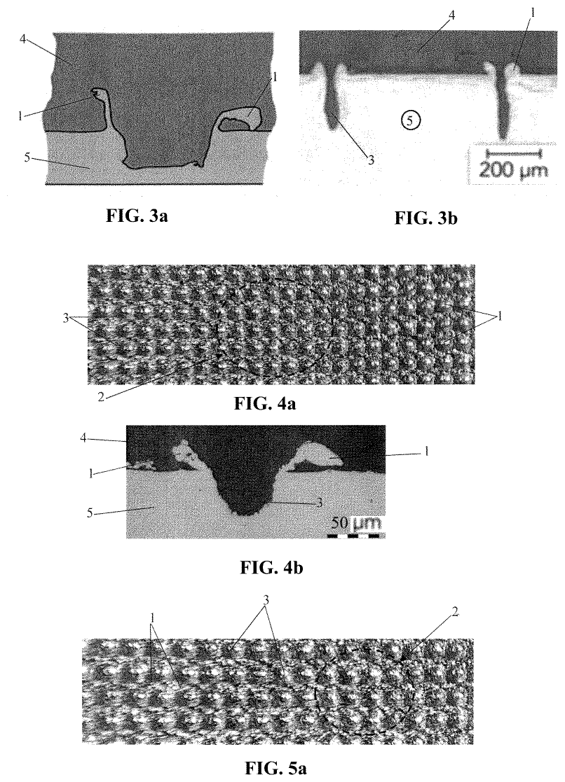

FIGS. 2, 3a and 3b show options for the location of distinct protuberances and recesses relative to the contact surface;

FIGS. 4a and 4b show particular versions of the prepared contact surface with an example of coating and enveloping relief asperities located at approximately an angle of 90° to the specified surface;

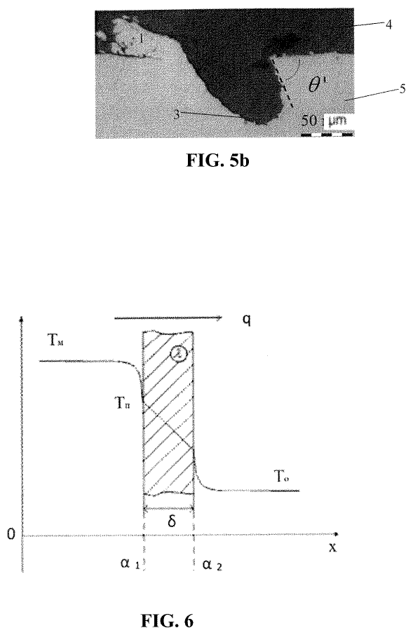

FIGS. 5a and 5b show specific variants of the prepared contact surface with an example of coating and enveloping relief asperities located at approximately an angle of 50°-80° to the said surface;

FIG. 6 shows the notation diagram for the thermophysical calculation of a layer of polymer material;

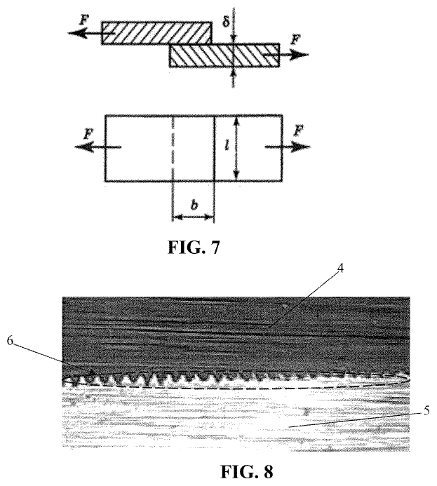

FIG. 7 shows a diagram for measuring the magnitude of forces to break a joint section;

FIG. 8 shows a variant of adhesion of materials with a mechanically pre-treated substrate surface.

The proposed method for bonding a layer of polymer material and a metal-containing substrate is explained by a specific example of implementation, which, however, is not the only possible one, but clearly demonstrates the accomplishment of the specified set of essential features of the specified technical result, as well as the solution of the existing technical problem.

It should be noted that the purpose of the subsequent description of the proposed invention is not to limit it to a specific embodiment, but, on the contrary, to cover all possible additions that do not go beyond the scope of the presented claims.

The proposed method of bonding a layer of polymer material and a metal-containing substrate to obtain a combined component for mechanisms can be implemented as follows.

The presented FIGS. 1-5a, 5b, and FIG. 8 show the elements and parts that are used in implementing the proposed technology for joining a layer of polymer material and a metal-containing substrate, namely:
1—protuberances;
2—area of relief asperities;
3—recesses;
4—polymer material;
5—metal-containing material (substrate);
6—joint area;
Θ is the angle of the walls of the recesses relative to the surface of the relief asperities.

FIG. 6 shows the following designations for thermophysical calculations for a combined unit, namely:
Tₒ is the temperature of the metal-containing material;
Tₘ is the temperature of the external environment (in the case of a plain bearing—the temperature of the lubricant (oil, pumped medium);
Tₙ is the temperature of the outer surface of the polymer material (in the case of a plain bearing—the layer of the bearing material);
h₁ is the heat transfer coefficient at the boundary “external environment/polymer material”;
h₂ is the heat transfer coefficient at the boundary “polymer material/metal-containing material”;
λ is the thermal conductivity coefficient of the polymer material;
δ is the thickness of the polymer material;
q is the heat flux density.

The following designations of the parameters for measuring shear forces are indicated in FIG. 7, namely:
F is the magnitude of the shear force;
b is the length of the area of conjugation of materials;
l is the width of the area of conjugation of materials;
δ is the thickness of the polymer material.

The production of a combined unit, according to the proposed invention, begins with the preparation of a less fluid material, namely, a metal-containing substrate (metal-containing material 5), onto which a more fluid layer is applied, i.e., polymer material 4.

The metal-containing material 5 is prepared by mechanical processing using drilling or cutting (milling) or electrochemical or electrical discharge machining or electric arc or plasma or electron beam welding und etc., until relief asperities are formed on the surface being processed with shaped contours of protuberances 1 and recesses 3, which are randomly or orderly distributed.

The said preparation is mainly carried out locally and, as a rule, is characterized by the arrangement of the said protuberances 1 and recesses 3 at an angle of 45-90° to the contact surface of the metal-containing substrate 5, which will subsequently ensure strong reliable adhesion with the fused polymer material 4, which penetrates into the set of relief asperities (see section of relief asperities 2), externally covers the asperities and, due to high fluidity, occupies and envelops the free volumes of the prepared protuberances 1 and recesses 3.

The obtained and prepared after processing surface with relief asperities (see relief asperity section 2) is subjected to control and diagnostic measurement of the geometric parameters of the obtained set of relief asperities (see relief asperity section 2) by contact and/or non-contact methods. Depending on the technical requirements, an operation can be carried out to minimize the volume of air cavities by applying prepregs or other inert fillers into the recesses of the relief asperities.

After preparing of the relief asperities of the metal-containing material 5, the polymer material 4 is bonded to the resulting set of relief asperities (see section of relief asperities 2). As a result, polymer material 4 in a partially molten state is applied with hot pressing or spraying, the joined section of which penetrates into the set of relief asperities (see section of relief asperities 2), completely covers the asperities externally and, due to plasticity, occupies and envelops all free volumes of protuberances 1 and recesses 3 with their passages, providing a reliable and durable joint area.

The application of polymer material 4 to the set of relief asperities (see section of relief asperities 2) of metal-containing material 5 is performed with a thickness of at least 10 μm, which is necessary for complete coverage of the area of the set of relief asperities that have the form of chaotically or orderly distributed protuberances 1 and recesses 3. Wherein said protuberances 1 and recesses 3 can be of various shapes and configurations, have, as a rule, a complex structure and shaped contours with multiple passages, pores and microcracks and multi-level differences in height.

If the thickness of the polymer material 4 is decreased within 10-500 μm, ensures complete coverage of the relief asperities (see the section of relief asperities 2), the temperature gradient between the outer surface of the polymer material 4 and the heat-conducting metal-containing material 5 can be reduced to values of several degrees.

The table 1 below presents a comparison of theoretically calculated temperature gradients for polymer material 4 of different thicknesses with the following parameters, indicated in FIG. 6.

TABLE 1

| | | | Heat transfer coefficient | | |
|---|---|---|---|---|---|
| Tₒ | Tₘ | δ | of the layer, | Heat flux density, | Tₙ |
| ° C. | ° C. | μm | k, W/m² ° K | q, kW/m² | ° C. |
| 50 | 150 | 10 | 995.02 | 99.50 | 51 |
| 50 | 150 | 50 | 975.61 | 97.56 | 52 |
| 50 | 150 | 100 | 952.38 | 95.24 | 55 |
| 50 | 150 | 500 | 800.00 | 80.00 | 70 |
| 50 | 150 | 1000 | 666.67 | 66.67 | 83 |
| 50 | 150 | 2000 | 500.00 | 50.00 | 100 |

The table 1 and FIG. 6 can be used as a model of heat distribution in the bearing layer of a plain bearing manufactured according to the invention.

The temperature of the metal-containing material 5 of the bearing housing Tₒ is 50° C., the temperature of the lubricant (oil) Tₘ is 150° C., the thickness of the layer of the bearing material made of polymer (polymer material 4) 0 is in the range from 10 μm to 2 mm.

Heat transfer coefficient at the interface “external environment/polymer material” h₁-1000 W/(m²° K).

The large joint area of materials at the boundary “polymer material 4/metal-containing material 5” provides a significantly higher heat transfer coefficient h₂ than h₁ at the boundary “external environment/polymer material”, i.e. h₂»h₁=1000 W/(m²° K) and the h₂ can be neglected in the calculations.

The thermal conductivity coefficient of the polymer material is λ=2 W/(m° K).

Table 1 shows the calculated heat transfer coefficients of the lining, k, W/m²° K, heat flux density, q, kW/m² and temperature of the bearing layer Tn.

As a result of theoretical comparison, it was found that the calculated temperature of the bearing layer Tn (when using a polymer material thickness of 10 to 500 μm) will be 30-49° C. lower than the temperature with a thickness of 2 mm, which is mainly used at present, while the value of the flux of heat (q) dissipated from the friction zone will increase by 60-100%.

High coefficients of thermal expansion of polymer materials compared to metals lead to design disadvantages of the obtained combined units. The proposed method eliminates this disadvantage.

The same temperature as in table 1 and the average value of the coefficients of thermal expansion of polymer composite materials (a) in the range from 10-10-6/° C. to 100·10⁻⁶/° C. were used. The increase in the geometric dimensions of the bearing layer with a temperature difference of 100° C. is indicated below in the table 2, where parameter Tₒ is the temperature of the metal-containing material 5, parameter Tₘ is the temperature of the lubricant (oil), parameter δ is the thickness of the bearing material layer, and α₁, α₂ are the minimal and maximal coefficients of thermal expansion of the commonly used polymer materials.

TABLE 2

| | | | Increasing the thickness | Increasing the thickness |
|---|---|---|---|---|
| | | | of the lining under | of the lining under |
| Tₒ | Tₘ | δ | α₁ = 10 · 10⁻⁶/° C. | α₂ = 100 · 10⁻⁶/° C. |
| ° C. | ° C. | μm | μm | μm |
| 50 | 150 | 10 | 0.005 | 0.05 |
| 50 | 150 | 50 | 0.025 | 0.25 |
| 50 | 150 | 100 | 0.05 | 0.5 |
| 50 | 150 | 500 | 0.25 | 2.50 |
| 50 | 150 | 1000 | 0.5 | 5.00 |
| 50 | 150 | 2000 | 1.00 | 10.00 |

According to theoretically calculated data indicated in table 2, it has been established that the application of polymer material 4 with a thickness of 10-500 μm practically eliminates the influence of thermal expansion of materials (less 0.01 mm) and provides the enough tolerance for the plain bearing most sizes.

Due to the preferential orientation of the protuberances 1 and recesses 3 at an angle of 45-90° relative to the contact surface of the metal-containing material 5, in the case of applying a mechanical force in the direction perpendicular to the surface (separation), a vertical projection of the reaction force of the substrate acts on the polymer material 4 in the joint area 6, preventing the separation. When forces are applied in the tangential direction (shear), a projection of the reaction force of the substrate appears in the tangential direction, which prevents displacement of the bonded parts of the unit.

In this case, it has been established experimentally that preferable results are achieved with a density of protuberances 1 and recesses 3 from 50 to 1000 pcs/mm² (table 3) with a cross-sectional size from 20 to 100 μm.

The tangential value of the strength of the joint between the parts of the combined unit is defined as the ratio of the breaking force F divided by the contact area S=b*l of the section of metal-containing material 5 and polymer material 4 of thickness δ (see FIG. 7).

All other things being equal, the magnitude of the tensile force (F) of the joined materials is determined by the number and area of contact points between the materials in the tangential projection and the empirical coefficient k, characterizing the quality of adhesion at each point:

$$F = k {⊤}_{b} s ,$$

where s is the total area of the contact points of the materials in the tangential projection;
T_{b} is bending strength of the lining material (polymer material 4).

Table 3 provides data on the strength of the joint area 6 with different treatment options for the adhesion surfaces (a set of relief asperities) of the metal-containing

TABLE 3

| | | Strength of | Bending | |
|---|---|---|---|---|
| | Strength of | the joint | strength | |
| | the sample, | in the | of | Quality |
| | MPa as per | contacting | polymer | of |
| Substrate surface | ASTM | area, | layer T_{b}, | adhesion |
| preparation (sample) | D1002-10 | F/s, MPa | MPa | k, 10⁻³ |
| Metallization with | 2.02 ± 0.03 | 2 | 92 ± 6 | 22 |
| copper-nickel alloy | | | | |
| with grain size of | | | | |
| 0.15-0.25 mm | | | | |
| Consecutive rows of | 3 ± 1 | 26 | 320 ± 20 | 80 |
| 70 μm width at a | | | | |
| distance of 600 μm | | | | |
| Consecutive rows of | 11 ± 2 | 31 | 320 ± 20 | 98 |
| 70 μm width at a | | | | |
| distance of 200 μm | | | | |
| Consecutive rows | 3 ± 1 | 30 | 92 ± 6 | 326 |
| 50 μm wide at a | | | | |
| distance of 500 μm | | | | |
| Craters Ø100 μm | 25 ± 3 | 53 | 92 ± 6 | 577 |
| (FIG. 1b) randomly | | | | |
| located with a | | | | |
| density of | | | | |
| 60 pcs/mm² | | | | |
| Craters Ø70 μm | 18.0 ± 1.5 | 65 | 92 ± 6 | 706 |
| (FIG. 1a) orderly | | | | |
| located with a | | | | |
| density of | | | | |
| 72 pcs/mm² | | | | |
| Craters Ø30 μm | 20.5 ± 0.3 | 186 | 90 ± 15 | 2067 |
| (FIG. 1c) orderly | | | | |
| located with a | | | | |
| density of | | | | |
| 156 pcs/mm² | | | | |
| Craters Ø30 μm | 17.0 ± 3 | 154 | 65 ± 5 | 2373 |
| (FIG. 1c) orderly | | | | |
| located with a | | | | |
| density of | | | | |
| 156 pcs/mm² | | | | |
| Craters Ø30 μm | 62.0 ± 6 | 178 | 65 ± 5 | 2738 |
| (FIG. 1c) orderly | | | | |
| located with a | | | | |
| density of | | | | |
| 493 pcs/mm² | | | | |

The data obtained on different samples (see table 3) using various methods of substrate surface preparation show a significant excess of the quality of adhesion k for the presented method compared to other methods known from the prior art.

The proposed technology is distinguished by the possibility of carrying out the joining of dissimilar parts in a single production cycle, which significantly simplifies the task and minimizes labour and energy costs, promoting the effective use of the method on an industrial scale in the field of mechanical engineering, ensuring the successful and efficient mass production of combined components of mechanisms with high technical and operational indicators.

1-7. (canceled)

8. A method for bonding a polymer material and a metal-containing substrate to produce combined components of mechanisms, the method comprising:
providing a metal-containing substrate having a contact surface with a plurality of relief asperities having a surface density within the range of about 50 pcs/mm² and 1000 pcs/mm² and forming a plurality of protuberances and recesses with a cross-section within the range of about 20 μm and about 100 μm with at least one of the plurality of protuberances and recesses oriented at an angle of between about 45° and about 90° to the contact surface;
measuring the geometric parameters of the plurality of relief asperities;
applying polymer material in a molten state, at least partially, to the contact surface with a thickness of at least 10 μm to penetrate the plurality of relief asperities to form an external cover for the plurality of relief asperities that occupies and envelops free volumes of the plurality of protuberances and recesses to form a joint between the external cover and the metal-containing substrate; and
providing heat dissipation from the joint to reduce the amount of thermal expansion thereof;
wherein the heat dissipation produces a counterforce that prevents the separation or the displacement of the external cover and the metal-containing substrate when external mechanical force is applied thereto.

9. The method of claim 8, wherein the asperities are arranged orderly.

10. The method of claim 8, wherein the asperities are arranged chaotically.

11. The method of claim 8, wherein the preparation of the metal-containing substrate is performed mechanically.

12. The method of claim 11, wherein in that the mechanical preparation is performed by a technique selected from the group consisting of drilling, cutting, milling, electrochemical machining, electrical discharge machining, electric arc welding, and electron beam welding.

13. The method of claim 8, wherein the plurality of protuberances and recesses are made of chaotically located craters with each of the chaotically located craters having edges that rise above the contact surface and having passages extending therein.

14. The method of claim 8, wherein the recesses within the plurality of protuberances and recesses have a form selected from the group consisting of pores, holes, and a combination of pores and holes.

15. The method of claim 8, wherein the protuberances within the plurality of protuberances and recesses have edges formed by cooled material.

16. The method of claim 8, wherein the plurality of protuberances and recesses include of a set of relief rows having a distance therebetween that exceeds the cross-sectional size of a largest protuberance within the plurality of protuberances and recesses by no more than about 1.5 times.

17. The method of claim 8, further comprising:
applying at least one of prepregs and inert fillers to the recesses within the plurality of protuberances and recesses before bonding to minimize the volume of air cavities.
